(19) United States
(12) Patent Application Publication
(10) Pub. No.: US 2014/0231549 A1
(43) Pub. Date: Aug. 21, 2014

(54) FLUID DISPENSING SYSTEM

(71) Applicant: SENSILE PAT AG, HAEGENDORF (CH)

(72) Inventors: Helmut Thiemer, Sachseln (CH); Regina Marbet, Ruetschelen (CH); Alexandre Perrier, Liestal (CH)

(21) Appl. No.: 14/347,700

(22) PCT Filed: Sep. 27, 2012
(86) PCT No.: PCT/IB2012/055170

§ 371 Date: Mar. 27, 2014

(30) Foreign Application Priority Data
Sep. 28, 2011 (CH) 01601/11

(51) Int. Cl. A62C 11/00

(52) U.S. Cl. CPC B05B 11/3042
USPC 239/333

(57) ABSTRACT

A fluid dispensing system comprising a pump (4) and a dispenser spray head comprising at least one nozzle through which fluid to be dispensed exits, the pump (4) comprising a stator (14) and a rotor (12) mounted in a chamber of the stator and rotatably displaceable with respect to the stator (14) around an axis of rotation (Ar) and axially along said axis (Ar), said axial displacement of the rotor in a first axial direction (A1) configured to effect a pump filling operation drawing in fluid via an inlet (8) into the stator chamber and in an opposite second axial direction (A2) configured to effect a dispensing operation expulsing the fluid in the chamber out of an outlet (10) of the pump. The outlet of the pump is positioned in the rotor and the dispenser spray head is fluidly connected to the outlet of the pump and is positioned at or adjacent an axial output end (19) of the rotor. The dispenser spray head is configured to dispense fluid at least partially in a radial direction (R) and encircling the axis of rotation.

The present invention relates to a system for dispensing fluids, in particular liquids, in the form of a spray.

There are many applications in which liquids need to be sprayed, whereby the desired configuration of spray will depend on the application, and may include parameters such as flow rate and amount of liquid to be dispensed, droplet size, fluid jet diameter, fluid exit velocity, and spatial dispersion of liquid. In addition to the properties of the liquid (e.g. viscosity) and the pressure, the spray configuration will depend inter alia on the nozzle geometry, which in conventional systems is static, sometimes with an adjustable gap or outlet shape to vary the spray configuration. Conventional dispenser systems however are not good at wide spatial distribution of fluid in an accurately controlled manner, especially for fine dosage.

It is an object of this invention to have a dispensing system that enables a well controlled and consistent spatial delivery of fluid.

For certain applications it is advantageous to provide a fluid dispensing system that can dispense fluid radially outwards with fine control.

For certain applications it is advantageous to provide a fluid dispensing system that can dispense small quantities of fluid with fine control.

For certain applications it is advantageous to provide a fluid dispensing system that can dispense fluid with a consistent rate of delivery.

For certain applications it is advantageous to provide a fluid dispensing system that can be integrated within a container in a discrete manner and that allows a wide range of container design configurations.

It is advantageous to provide a fluid dispensing system that is compact and cost-effective.

It is advantageous to provide a fluid dispensing system that is easy to operate.

Objects of this invention have been achieved by providing a dispensing system according to claim 1.

Disclosed herein is a fluid dispensing system comprising a pump and a dispenser spray head comprising at least one nozzle through which fluid to be dispensed exits. The pump comprises a stator and a rotor mounted in a chamber of the stator and rotatably displaceable with respect to the stator around an axis of rotation and axially along said axis, said axial displacement of the rotor in a first axial direction configured to effect a pump filling operation drawing in fluid via an inlet into the stator chamber and in an opposite second axial direction configured to effect a dispensing operation expulsing the fluid in the chamber out of an outlet of the pump. The outlet of the pump is positioned in the rotor and the dispenser spray head is fluidly connected to the outlet of the pump and is positioned on or proximate an axial output end of the rotor, the dispenser spray head being configured to dispense fluid at least partially in a radial direction and encircling said axis of rotation.

Fluids to be dispensed may include liquids, gases, mixtures of gas and liquid, gels and other flowable substances. The fluid dispensing system according to embodiments of the invention is particularly well suited for spraying liquids.

In an advantageous embodiment, the rotor comprises first and second axial extensions of different diameters, mounted in corresponding first and second chamber portions of the stator chamber, first and second seals mounted in the stator housing and sealingly surrounding the first and second axial rotor extensions, the rotor extensions comprising fluid supply channels that, in conjunction with the respective sealing rings, operate as valves that open and close communication between the inlet of the pump and the chamber portions, respectively the chamber portions and the outlet of the pump, as a function of the angular displacement of the pump rotor.

In an advantageous embodiment, the outlet of the pump is positioned in the rotor second axial extension and the rotor second axial extension has a diameter smaller than the diameter of the rotor first axial extension. The outlet of the pump may advantageously exit the axial output end of the rotor.

In an advantageous embodiment, the inlet is arranged in line with the axis of rotation and opposite the axial output end of the rotor. The outlet of the pump is positioned in the rotor second axial extension, which preferably comprises an outlet cavity fluidically connected with the outlet and the dispenser head. The rotor second axial extension has a diameter bigger than the diameter of the rotor first axial extension.

In an advantageous embodiment, the dispenser spray head is immovably mounted to or extending from the axial output end of the rotor and rotates with the rotor.

The dispenser spray head may be in the form of a separate component mounted to the axial output end of the rotor, although it is also possible to have a spray head integrally formed with the rotor as a single component.

The dispenser spray head may have a diameter greater than the diameter of the rotor axial output end, or may have a diameter that is equal to or less than the diameter of the rotor axial output end.

The dispenser spray head may advantageously comprise a plurality of nozzles, the nozzles being directed at one or more angles (α) with respect to the radial direction. The projection direction of the nozzles may be at any chosen angle, for instance in a range where−80°<α<+90°, or less, for instance where−60°<α<+90°. The angular rotational position of the pump expel range, which may be preferably in a range of 60° to 120°, for instance 90° or around 90°, is dependant on and fixed by the pump configuration, and allows to choose where the pump expel begins and ends, and thus to configure the start and stop angle shaping the angular distribution of spray around the rotational axis. The configuration of the pump valve is determined by the position of the liquid supply channels, the shape and position of the seals, and the axial displacement characteristic of the rotor as a function of rotation. It is thus possible to generate a large range of unsymmetrical or symmetrical spray patterns by configuring the combination of parameters including: fluid throughput, angle direction a of each nozzle relative to the radial direction R, angular opening width of each nozzle element, number and spatial distribution of nozzles, and configuration of the pump valve determining the rotational angle of the fluid expel operation. This allows, for instance to have more fluid into a certain spray area positioned relatively far from the device and less fluid and/or at an different angle in the relatively near spray area, for instance laterally adjacent or behind the dispenser system.

The plurality of nozzles may all be directed at the same angle with respect to the radial direction, or may be directed at two or more different angles.

In advantageous embodiments, the rotor axial output end extends outside of the stator.

In another embodiment, the dispensing system may comprise a dispenser spray head that is fixedly and statically mounted to an end wall of a housing of the stator, adjacent the outlet end of the rotor that is positioned within the housing.

The dispenser spray head may comprise a flexible cap having a peripheral lip biased against the stator housing end wall and displaceable under fluid pressure to define, with the stator housing end wall, a spray nozzle, for instance an annular spray nozzle.

The rotor and stator may advantageously comprise complementary cam mechanisms effecting the axial displacement of the rotor in both opposing axial directions as a function of angular displacement of the rotor.

Further objects and advantageous features of the invention will be apparent from the claims, from the detailed description, and annexed drawings, in which:

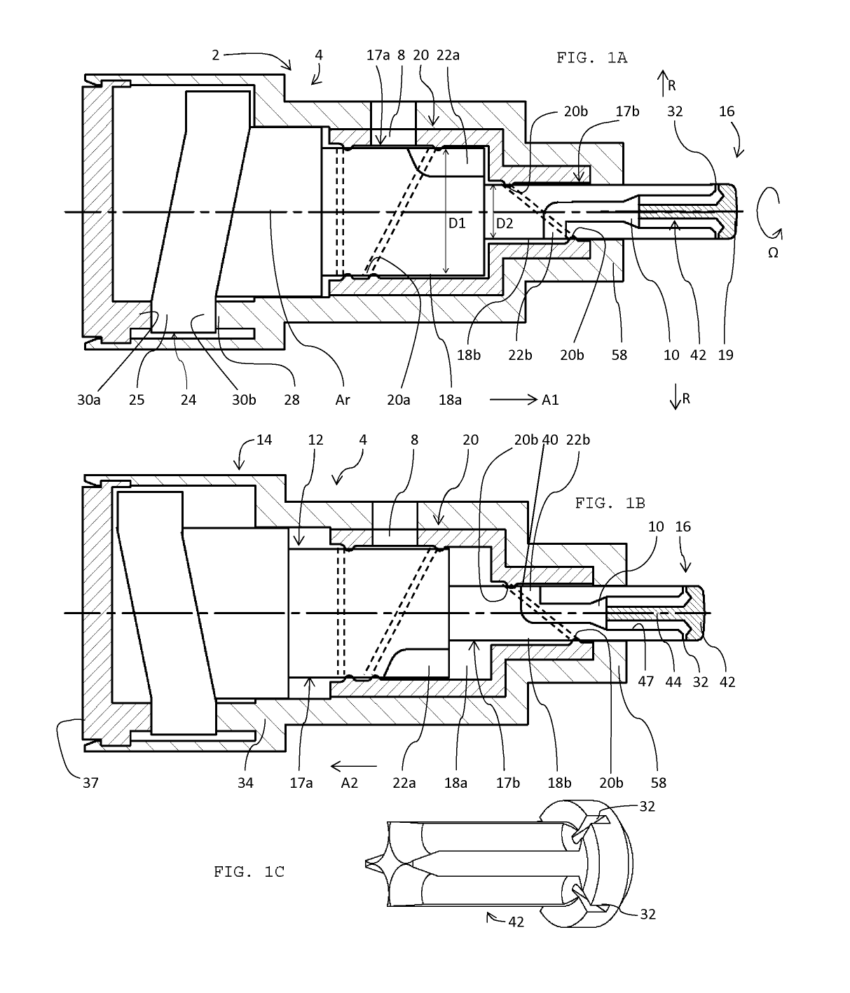

FIGS. 1a and 1b are cross-sectional views through a fluid dispensing system according to a first embodiment of the invention, FIG. 1a illustrating an end of expulsion position of a pump cycle and Fig. 1b an end of fill position of the pump cycle;

FIG. 1c is a perspective enlarged view of a dispensing head insert of the dispensing system of FIGS. 1a, 1b;

FIG. 2 is a schematic cross-sectional view through a dispenser head according to a second embodiment of the invention;

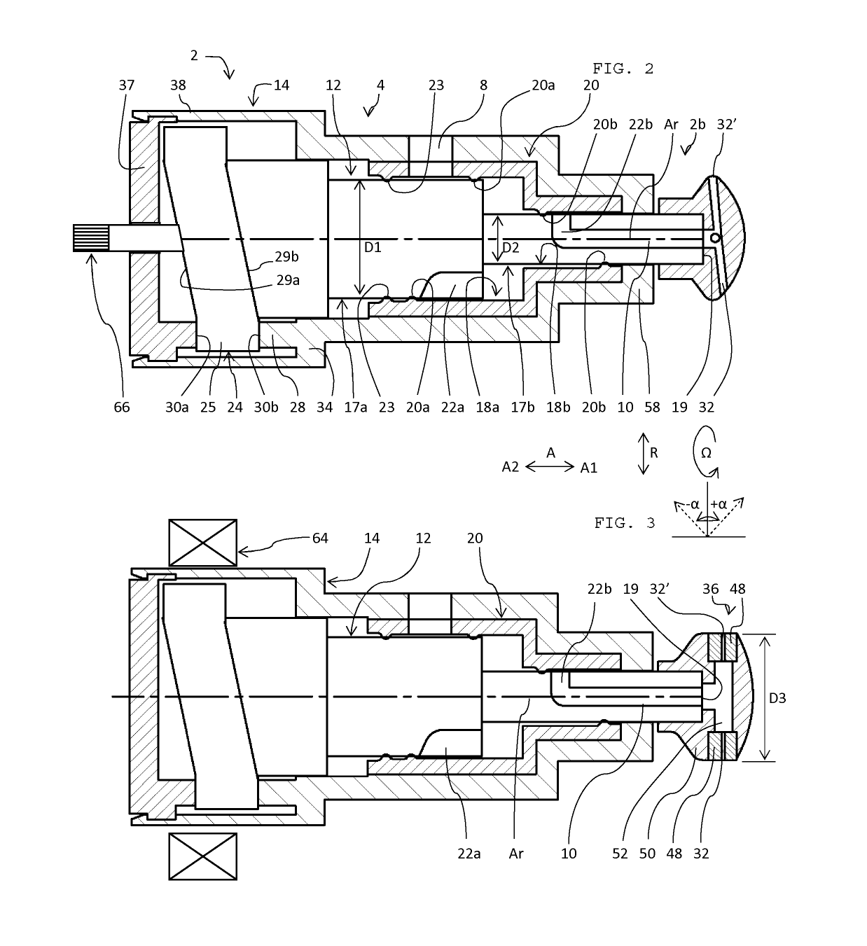

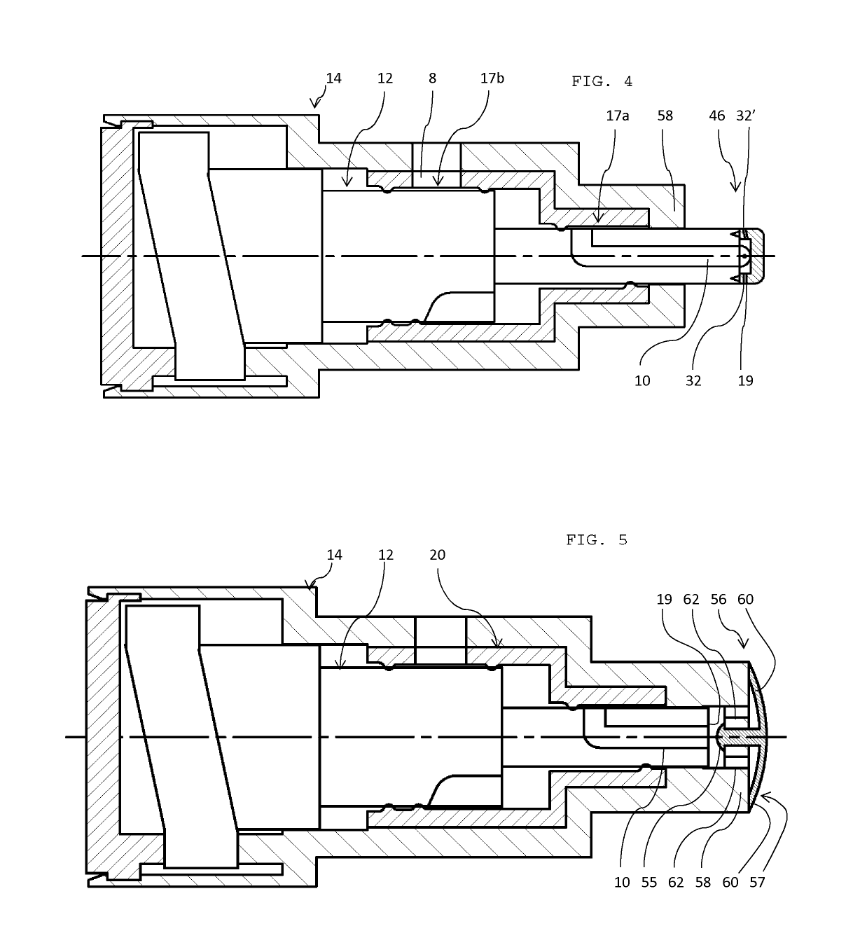

FIG. 3 is a schematic cross-sectional view through a dispenser head according to a third embodiment of the invention;

FIG. 4 is a schematic cross-sectional view through a dispenser head according to a fourth embodiment of the invention;

FIG. 5 is a schematic cross-sectional view through a dispenser head according to a fifth embodiment of the invention;

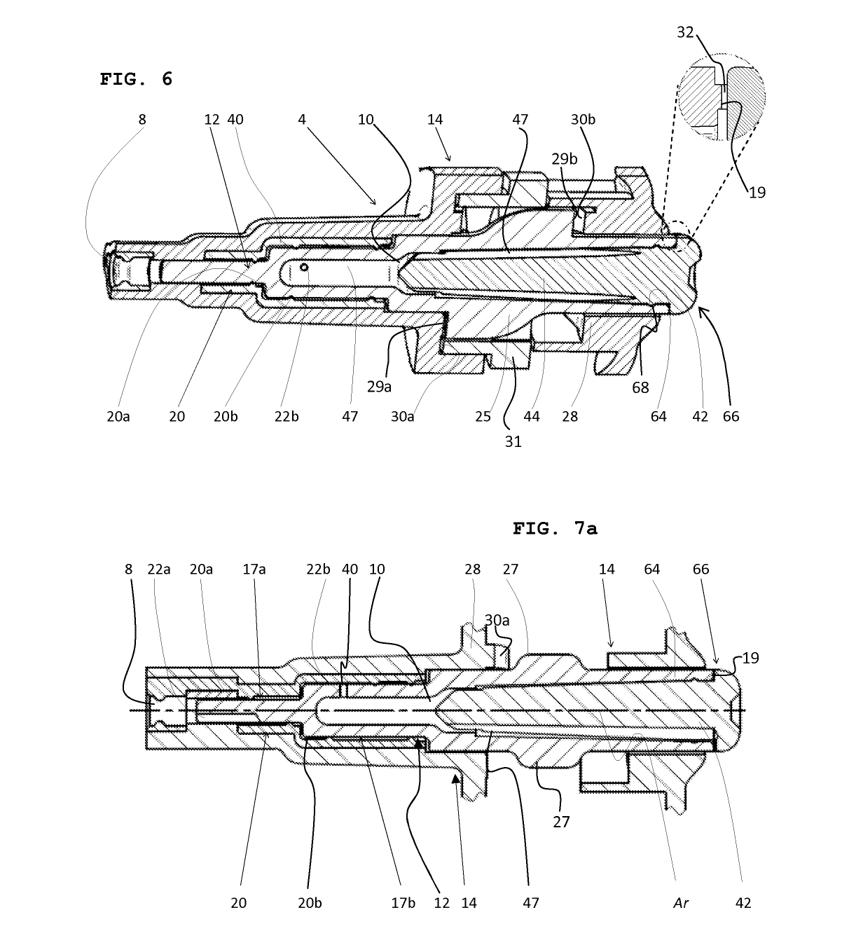

FIG. 6 is a perspective view of a dispenser head cut in half along an axis of rotation according to a sixth embodiment of the invention;

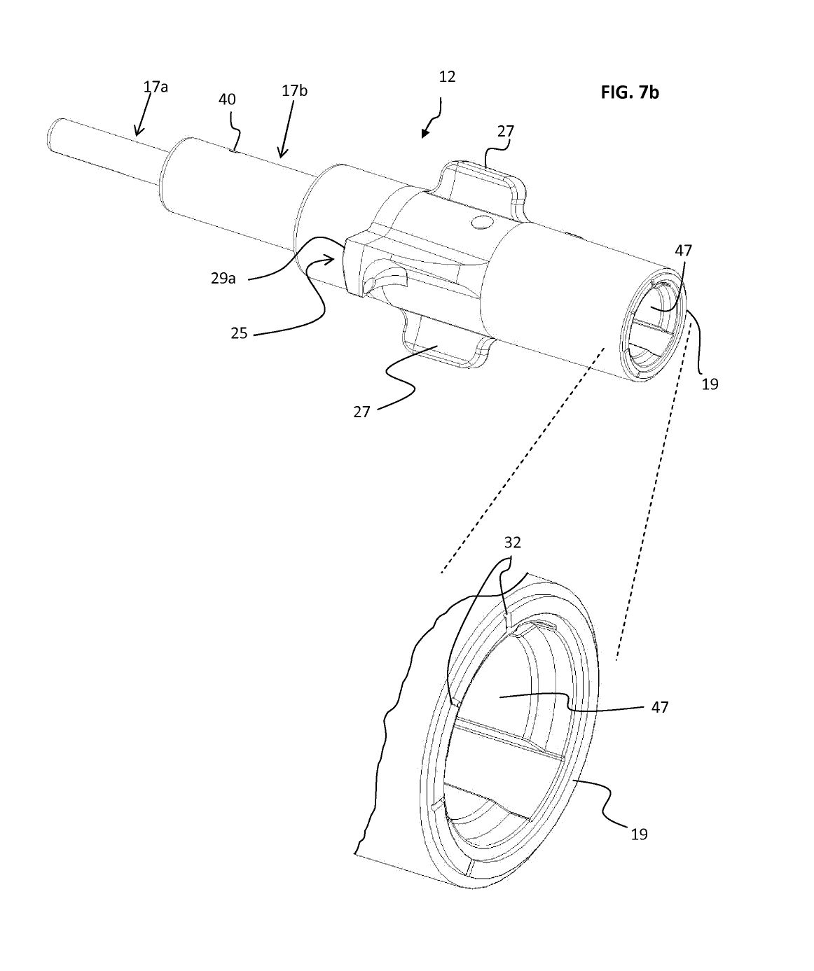

FIG. 7a is a schematic cross-sectional view through a dispenser head according to a seventh embodiment of the invention,

FIG. 7b is a perspective view of the rotor of the embodiment of FIG. 7a;

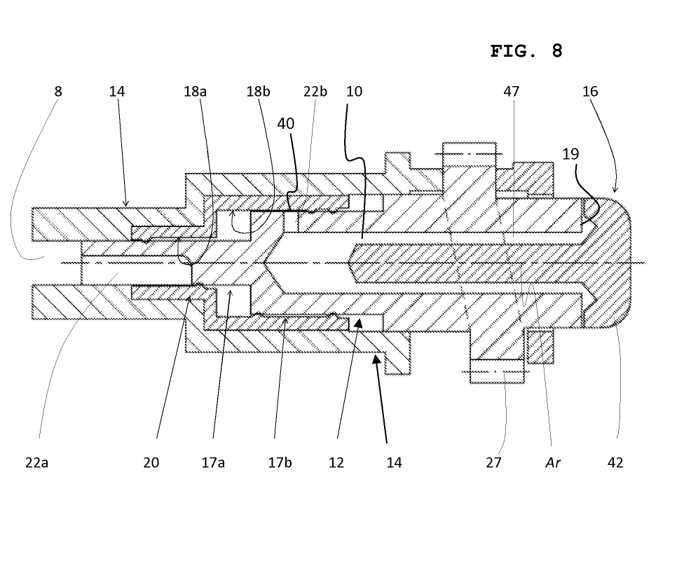

FIG. 8 is a schematic cross-sectional view through a dispenser head according to a eighth embodiment of the invention.

Referring to the figures, a dispensing system 2 according to various embodiments of the invention comprises a dispenser pump 4 and a dispenser spray head 16, 26, 36, 46, 56, 66 mounted to an outlet of the pump. The pump comprises an inlet 8 communicating with the inside of a container (not shown) comprising a fluid to be dispensed or connected to a tube or other conduit connected to a source or supply of fluid to be dispensed, for instance a liquid.

The dispenser pump 4 may advantageously have a configuration and pumping action similar to the pump described in WO2007/074363, except for differences described herein. The pump 4 comprises a stator 14 and a rotor 12 rotatably mounted in the stator. The stator 14 comprises a housing 34 and a seal valve system 20 defining a chamber 18a, 18b, hereinafter called pump chamber, within which first and second axial extensions 17a, 17b of the rotor are mounted. The valve seal system 20 comprises first and second seals 20a, 20b mounted in the stator housing 14 and define sealing rings sealingly surrounding the first and second axial extensions 17a, 17b respectively of the rotor. Fluid supply channels 22a, 22b are provided in the first and second axial extensions of the rotor.

The first rotor axial extension 17a has a generally cylindrical shape with a diameter D1 that is in certain embodiments greater than the diameter D2 of the second axial extension 17b which also has a generally cylindrical shape, as shown in FIGS. 1 to 5. In the embodiments shown in FIGS. 6 to 8, the diameter D1 of the first rotor axial extension 17a is smaller than the diameter D2 of second axial extension 17b. The axial extensions with fluid supply channels 22a, 22b cooperate with the respective first and second seals to create first and second valves that open and close fluid communication across the respective seal as a function of the angular and axial displacement of the rotor.

In the embodiments illustrated in FIGS. 6 to 8, the inlet 8 is arranged in line with the axis of rotation Ar and opposite an axial output end 19 of the rotor 12. The arrangement of the inlet 8 as shown in FIGS. 6 to 8 allows to connect for example an external tube (not shown) supplying the fluid to be dispensed in-line with the central axis of the rotor 12. An advantage of this arrangement is the small diameter of the dispensing system. Depending on the embodiment, the inlet may therefore be in-line with the rotor axis or orthogonal to the axis. In the embodiments according to FIGS. 6 to 8, the fluid is pumped from the inlet 8, via the first fluid supply channel 22a, the pump chamber 18a, 18b and the second fluid supply channel 22b into an outlet cavity 47, from which the fluid is dispensed. The outlet 10 is fluidically connected with the second fluid supply channel 22b and the outlet cavity 47. The outlet cavity 47 is arranged in the rotor 12, extending from the axial output end 19 of the rotor 12 towards the first rotor axial extension 17a, and fluidically connected with the dispenser head 16, 66 and the nozzles 32, 32′ respectively. The outlet cavity 47 does not change its volume during the pump operation.

The embodiments of FIGS. 6 to 8 comprise a relatively big outlet cavity 47; however the outlet cavity 47 may be smaller for instance similar as shown in FIGS. 1A and 1B, as long as it is fluidically connected with the outlet 10 of the pump 4.

The second fluid supply channel 22b in the rotor second axial extension 17b, of smaller or bigger diameter than the rotor first axial extension 17a, also forms the outlet 10 of the pump 4, leading into the dispenser head 16, 26 36, 46, 56, 66. In the embodiments shown, the second fluid supply channel comprises a channel buried in the rotor extending from the outlet 10 to an orifice 40 at the surface of the second axial extension 17b. The orifice 40 is configured to pass across the second seal 20b during the rotation of the rotor so as to enter the pump chamber 18b during the fluid dispensing cycle portion, respectively exit the chamber 18b to close the outlet during the filling cycle portion of the pump chamber. The buried outlet channel 10 may extend to an axial end 19 of the rotor as illustrated in the various embodiments shown, or may exit the rotor radially before reaching the axial extremity of the rotor.

The first fluid supply channel 20a may be in the form of a groove or open channel in the surface of the rotor or may be buried below the rotor surface except for orifices feeding onto the rotor surface.

In the embodiments illustrated in FIGS. 1-4, the second rotor axial extension 17b extends through the main housing portion 34 of the stator externally of the stator to be accessible from the outside of the stator. In the embodiments illustrated in FIGS. 6-8, the rotor also extends externally of the stator to an outlet end 19 of the rotor accessible from the outside of the stator, however the second rotor axial extension 17b remains fully within the stator housing.

In a variant, for instance as illustrated in FIG. 5, the rotor second axial extension may however be contained within the stator housing, i.e. not extending out of the stator housing, and the dispenser head in communication with the pump outlet 10, positioned at least partially outside of the stator housing.

In a variant (not shown) where the rotor second axial extension is contained within the stator housing and the dispenser head is attached to an outlet end 19 of the rotor, the dispenser head may extend into the stator housing to be fixed to the rotor second axial extension.

In embodiments illustrated in FIGS. 1a-1c, 2, 3, 4 and 6 to 8 the dispenser spray head 16, 26, 36, 46, 66 is advantageously mounted on the outlet end 19 of the rotor and thus rotates with the rotor. The dispenser spray head comprises one or more nozzles 32 directed at least partially radially outwards, configured to spray fluid radially outwards around the axis of rotation Ar. Each nozzle may be directed at any chosen angle a with respect to a plane orthogonal to the axis Ar, from −90° to +90°, preferably in the range of −80° to +80°, depending on the desired distribution of spray, from a narrow cone directed forwardly (in direction A1), to a radially projected spray in direction (R), to a rearwardly (in direction A2) directed spray. In variants with a plurality of nozzles 32, 32′ the nozzles may be directed at a same angle with respect to the axis Ar, or at different angles to generate different cones of spray. A large range of fluid spray configurations may thus be generated. The combined effect of the spray nozzles in operation may be configured to generate one or more cones of spray up to 360° around the axis Ar or partial cones of spray, for instance covering less than 180° around the axis, for instance 90° or less per nozzle. The fluid dispensing system according to the invention can thus generate a spray geometry that combines both the choice of an exit angle α with respect to the radial direction R and a desired angle of distribution around the axis Ar that may be less than 180°, even less than 90°, depending on the pump seal and fluid channel configuration that determines the angle of rotation Ω during which the pump expels liquid.

The nozzles may have various dimensions and orifice shapes configured to generate a fine or less fine fluid jet with a chosen cross-sectional profile such as cylindrical or rectangular. The diameter D3 of the spray head may also have various dimensions to provide nozzles 32 that exit close to the axis of rotation Ar as in the embodiments of FIGS. 1a-1c and 4, where the spray head diameter is essentially equivalent to (or less than) the rotor second axial extension diameter D2, or further from the axis as shown in FIGS. 2 and 3 where the spray head diameter D3 is greater than the rotor second axial extension diameter D2.

In the embodiment of FIGS. 1a-1c and 6 to 8, the dispenser spray head 16, 66 comprises an insert 42 fixed to the outlet end 19 of the rotor and having a core portion 44 extending into the outlet cavity 47 of the rotor configured to direct fluid to each of the nozzles 32. Instead of the individual nozzles 32, in this embodiment it is also possible to provide a variant where there is a single annular nozzle, fully encircling the spray head. The insert may be made of injected plastic or of another material and bonded or welded or fixed by mechanical means (e.g. latching projections) to the rotor.

The dispenser head 66 according to the embodiments of FIGS. 6 and 7 has a conical core portion 44, which fits into the conically shaped outlet cavity 47. A holding element 64 is arranged around the conical core portion 44. The holding element 64 is configured to engage with a cognate groove 68 in the rotor 12, so that the dispenser head 66 may be connected to the rotor 12. The dispenser head 66 further also comprises a plurality of nozzles 32 (see enlarged detail of FIG. 6) through which the fluid may be dispensed. Alternatively the nozzle elements are formed at the corresponding axial end of the rotor while the dispenser head has a flat counter face interacting with the rotors end face.

In the embodiment of FIGS. 2 and 3, the dispenser spray head 26 is a separate component mounted over the outlet end 19 of the rotor, and may be made of injected plastic or of another material and bonded or welded or fixed by mechanical means (e.g. latching projections) to the rotor. In the variant of FIG. 2 there are a plurality of nozzles 32, 32′ pointing at different angles α, whereas in the variant of FIG. 3 the nozzles point at the same angle, in the example illustrated at 90° with respect to the axis Ar. In the latter embodiment, the nozzles are formed in inserts 48 mounted in the spray head body 50. This enables the nozzles to be formed in a different material to the body, and/or to form very fine nozzles compared to the dimensions of the fluid flow channel 52 within the spray head 36.

In the embodiment of FIG. 4, the spray head 46 comprises cap portion 42′ fixed onto the outlet end 19 of the rotor with essentially the same diameter as the rotor end and having nozzles 32, 32′ formed directly in the cap portion 42′.

In the embodiment of FIG. 5, the dispenser spray head 56 is not mounted on the rotor but formed on the stator housing, the rotor outlet end 19 being positioned within the housing. The dispenser spray head comprises an elastic or flexible cap 57, for instance made of an elastomer, fixed over an end wall 58 of the stator housing and comprising a flexible lip 60 pressing circumferentially against the end wall 58. One or more outlet orifices 62 traverse the end wall 58 to allow the fluid to be pumped out through the end wall 58 and redirected radially by the flexible cap, whereby the flexible lip lifts off the end wall under the pressure of the pumped fluid to define the spray nozzle gap. The cap 57 may comprise a central fixing stud 55 for fixing the cap to the stator housing provided with a complementary through-hole.

In a preferred embodiment, the axial movement (A) of the rotor 12 is advantageously effected by a double cam mechanism 24 that defines the axial displacement of the rotor in both axial directions, namely in the pumping action direction A1 and in the pump filling direction A2, as a function of the rotor angular displacement Ω. The cam mechanism 24 comprises a rotor cam 25 and a stator cam 28. The stator cam may be in the form of one or more protrusions 30a, 30b and the rotor cam in the form of annular cam surfaces 29a, 29b, or vice-versa.

In the embodiments of FIGS. 1-5 a first cam surface 29a of the rotor cooperates with a first stator cam protrusion 30a to define the pump dispensing action (i.e. expulsing fluid out of the pump) and an opposed second cam surface 29b of the rotor cooperates with a second stator cam protrusion 30b to define the pump filling action (i.e. drawing-in of fluid into the pump). The stator cam protrusion may also be in the form of a protrusion protruding inwardly from a side wall of the stator in the radial direction R and received in a circumferential groove of the rotor.

The cam mechanism may be inversed in that the stator provides the annular cam surfaces and the rotor first and second cam protrusions either side of the stator annular cam. In the embodiments of FIGS. 6-8 a first cam protrusion 29a of the rotor cooperates with a first stator surface 30a to define the pump filling action (i.e. drawing-in of fluid into the pump) and an opposed second cam protrusion 29b of the rotor cooperates with a second stator cam surface 30b to define the pump dispensing action (i.e. expulsing fluid out of the pump).

The above-described double cam mechanism is advantageous in that the cam elements may be manufactured of injected plastic or other materials and assembled or integrally formed with the rotor, respectively stator of the pump, in a very cost effective configuration. The double cam mechanism, in conjunction with a pump according to this invention, is also advantageous in that one can pump in both directions, which may be used to prevent liquid dripping off the spray head after pump is switched off, by retracting fluid from the nozzles.

In the embodiment illustrated in FIG. 1, the stator housing 14 may comprise a main housing portion 34 encompassing the rotor chamber, and a cap portion 37 to lock the rotor in the main housing. The cap portion 37 may also be advantageously made of an injected plastic, but may also be made of a stamped and formed sheet metal for a cost effective configuration, and fixed to the main housing portion by elastic latches 38 or other mechanical fixing means that allow rapid assembly of the cap portion to the main housing portion without additional fixing means. The cap portion may also be fixed to the main housing portion by bonding or welding (e.g. ultrasonic welding). The seal valve system 20 may advantageously be made of an elastomeric material injection molded in the stator main housing portion, as a single element. Assembly of the dispenser system components may advantageously be performed principally or solely by insertion of the components in the axial direction A for a very cost effective assembly. The rotor may advantageously be assembled by axial insertion in the stator main housing portion and seal valve system 20, followed by pressing the cap portion over the open end of the main body portion until the latches 38 clip and lock on to the cap portion, and insertion and mounting of the dispenser spray head on the outlet end 19 of the rotor.

The rotor may be driven in rotation by an electrical drive, for instance comprising electromagnets 64 in the stator (see FIG. 3) surrounding a drive portion of the rotor provided with permanent magnets. The rotor may also be driven by a mechanical or electrical drive mechanically coupled to the rotor, for example via a drive pinion 66 (see FIG. 2) extending from the rotor at an end of the dispensing system distant from the spray head. In the embodiments illustrated in FIGS. 6-8 the rotor comprises one or more paddles 27 that are engaged by an external drive (e.g. a portion 31 of which is illustrated in FIG. 6).

The invention may advantageously be used for a generating radially or conically distributed sprays of fluid, such as liquids.

The use of a pump as described herein in a fluid dispensing system is particularly advantageous for a number of reasons. Firstly, the pump can draw fluid from a container at sub-atmospheric pressures, in other words creating a partial volume, which allows the fluid contained in the reservoir to be drawn out without replacing the volume of dispensed fluid that exits the reservoir with ambient air. The amount of fluid dispensed depends only on the number of turns effected by the rotor of the pump and not on the pressure difference between the fluid reservoir and ambient pressure, nor on the resistance to flow of dispensed fluid in the pump or outlet nozzle. The dispensing system according to this invention can spray very small quantities of fluid finely controlled in a very evenly distributed manner around and radially outwards from the spray head. Also, the pump used in the present invention enables accurate dosage of the dispensed fluid and obviates the need for valves since the pump itself integrates a valve function.

1-18. (canceled)

19. A fluid dispensing system comprising a pump (4) and a dispenser spray head comprising at least one nozzle through which fluid to be dispensed exits, the pump (4) comprising a stator (14) and a rotor (12) mounted in a chamber of the stator and rotatably displaceable with respect to the stator (14) around an axis of rotation (Ar) and axially displaceable along said axis of rotation (Ar), an axial displacement of the rotor in a first axial direction (A1) configured to effect a pump filling operation drawing in fluid via an inlet (8) into the stator chamber, and an axial displacement of the rotor in an opposite second axial direction (A2) configured to effect a dispensing operation expulsing the fluid in the chamber out of an outlet (10) of the pump, wherein the outlet of the pump is positioned in the rotor and the dispenser spray head is fluidly connected to the outlet of the pump and is positioned at or adjacent an axial output end (19) of the rotor, the dispenser spray head being configured to dispense fluid at least partially in a radial direction (R) and encircling said axis of rotation.

20. The dispensing system according to claim 19, wherein the rotor comprises first and second axial extensions (17a, 17b) of different diameters, mounted in corresponding first and second chamber portions (18a, 18b) of the stator chamber, first and second seals (20a, 20b) mounted in the stator housing and sealingly surrounding the first and second axial rotor extensions, the rotor extensions comprising fluid supply channels (22a, 22b) that, in conjunction with the respective sealing rings, operate as valves that open and close communication between the inlet (8) of the pump and the chamber portions, respectively the chamber portions and the outlet (10) of the pump, as a function of the angular displacement of the pump rotor.

21. The dispensing system according to claim 20, wherein the outlet of the pump is positioned in the rotor second axial extension and the rotor second axial extension has a diameter (D2) smaller than the diameter (D1) of the rotor first axial extension.

22. The dispenser system according to claim 20, wherein the inlet (8) is arranged in line with the axis of rotation (Ar) and opposite the axial output end (19) of the rotor and wherein the outlet of the pump is positioned in the rotor second axial extension and rotor second axial extension has a diameter bigger than the diameter of the rotor first axial extension.

23. The dispensing system according to claim 19, wherein the outlet (10) of the pump exits an axial output end (19) of the rotor.

24. The dispensing system according to claim 19, wherein the dispenser spray head is immovably mounted to or extending from an axial output end of the rotor and rotates with the rotor.

25. The dispensing system according to claim 24, wherein the dispenser spray head is in the form of a separate component mounted to the axial output end of the rotor.

26. The dispensing system according to claim 24, wherein the dispenser spray head has a diameter (D3) greater than the diameter of the rotor axial output end.

27. The dispensing system according to claim 24, wherein the dispenser spray head has a diameter that is equal to or less than the diameter of the rotor axial output end.

28. The dispensing system according to claim 19, wherein the dispenser spray head comprises a plurality of nozzles directed at one or more angles (α) with respect to the radial direction (R), where −80°<α<+90°.

29. The dispensing system according to claim 28, wherein the plurality of nozzles are all directed at the same angle with respect to the radial direction (R).

30. The dispensing system according to claim 28, wherein certain nozzles of the plurality of nozzles are directed at different angles with respect to the radial direction (R).

31. The dispensing system according to claim 19, wherein a rotor axial output end (19) extends outside of the stator.

32. The dispensing system according to claim 19, wherein a rotational angle of the pump dispensing operation is in a range of 60° to 120°.

33. The dispensing system according to claim 32, wherein the rotational angle of the pump dispensing operation is around 90°.

34. The dispensing system according to claim 19, wherein the dispenser spray head (56) is fixedly mounted to an end wall of a housing of the stator, adjacent the outlet end (19) of the rotor positioned within the housing.

35. The dispensing system according to claim 34, wherein the dispenser spray head comprises a flexible cap having a peripheral lip (60) biased against the stator housing end wall and displaceable under fluid pressure to define, with the stator housing end wall, a spray nozzle.

36. The dispensing system according to claim 19, wherein the rotor and stator comprise complementary cam mechanisms (29a, 29b, 30a, 30b) defining the axial displacement of the rotor in opposing axial directions (A1, A2) as a function of angular displacement of the rotor.
